(19) United States
(12) Patent Application Publication
(10) Pub. No.: US 2004/0074832 A1
(43) Pub. Date: Apr. 22, 2004

(54) Apparatus and a method for the disinfection of water for water consumption units designed for health or dental care purposes

(76) Inventor: Peder Holmbom, Orkidegangen (SE)

Correspondence Address: YOUNG & THOMPSON, 745 SOUTH 23RD STREET 2ND FLOOR, ARLINGTON, VA, 22202

(21) Appl. No.: 10/469,148

(22) PCT Filed: Feb. 22, 2002
(86) PCT No.: PCT/SE02/00315

(30) Foreign Application Priority Data
Feb. 27, 2001 (SE) 0100656-8

(51) Int. Cl. C02F 1/02

(52) U.S. Cl. 210/175

(57) ABSTRACT

The invention relates to an apparatus and a method for the disinfection of water for water consumption units (3) designed for health and dental care purposes. According to the invention, a cold-water flow is diverted from an existing service conduit (1), which via a main valve (12) is divided in a first part flow to a heater (7) in which the water is heated to a bactericidal temperature, as well as a second part flow to a heat exchanger (8) in which the cooling water cools the disinfected, hot water from the heater to a temperature acceptable to the tissue of man. From the heat exchanger (8), the disinfected, cooled water is fed to the consumption unit (3), and the cooling water that has served its time from the heat exchanger (8) is evacuated to a drainage (6).

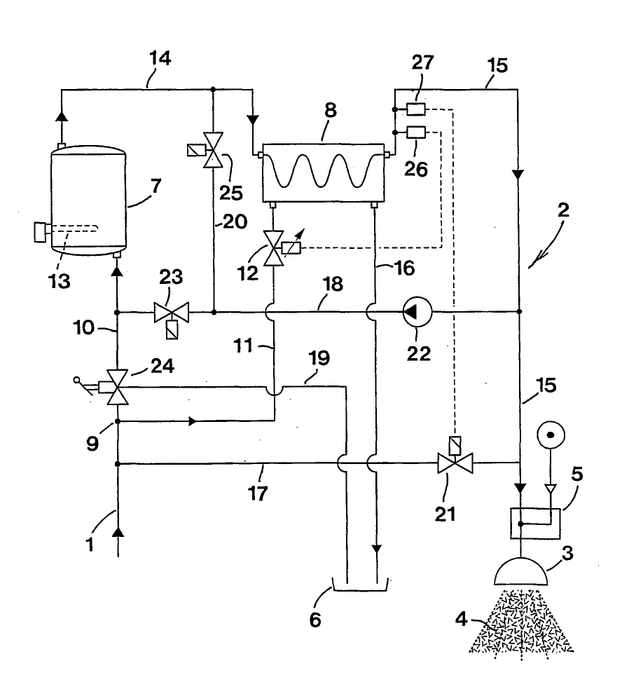

### BACKGROUND OF THE INVENTION

In general health care as well as dental care, individual consumption units are found, from which water may be taken out for different forms of treatment of patients. For instance, adjacent to every dental chair at dentist's surgeries, there is an adjustable unit for the provision of one or more treatment devices with water. The water supply takes place via the ordinary cold-water service of the property in question. More precisely, cold water (approx. 8-12° C.) from the service conduit is mixed in a thermostat mixer with hot water (approx. 55-65° C.) from a boiler room or the like, in such quantity ratios that the consumption water receives a temperature of approximately 34° C.

Investigations have shown that different bacteria, such as legionellapneumophila bacteria, heterotrophic bacteria, etc., are frequently occurring in fresh water of the type that is found in cold-water services. Such water is usually harmless to drink, but may constitute a danger to health at forming of aerosols, which are inhaled by man. In the dental care, aerosols frequently arise at drilling, blasting and the like. Such as has been mentioned above, the temperature of the water amounts in that connection to approximately 34° C. This is a temperature at which, for instance, legionella bacteria grow in an optimum way; something which means that certain patients risk to be affected by different states of ill-health. This is particularly valid for patients which already have a degraded immune defence, e.g. as a consequence of cancer, diabetes, kidney diseases, chronic diseases in respiratory organs, etc. However, also people of full health may be affected by for instance Legionnaire's disease or Pontiac fever.

In order to manage the above-mentioned problems, attempts have been made to disinfect water by means of chlorine, ultraviolet light, as well as different types of purifying filters. Examples of disinfecting apparatuses that make use of chemical treatment of water are previously described in EP 0734692, U.S. Pat. No. 4,545,956 and U.S. Pat. No. 5,785,523. The previously known disinfecting apparatuses are, however, complicated and expensive in manufacture as well as in operation. Furthermore, chemical treatment of the water has at times proven less efficient since bacteria may survive in amoebas and in the biofilm that is formed in tubes and conduits.

### OBJECTS AND FEATURES OF THE INVENTION

The present invention aims at obviating the above-mentioned problems and at providing an improved apparatus and an improved method for the disinfection of water for such water consumption units that are used in the health and dental care. Therefore, a primary object of the invention in a first aspect is to provide a disinfecting apparatus which is structurally simple and which may remove bacteria from consumption water of a suitable temperature in an effective way without the help of chemicals. An additional object is to create a disinfecting apparatus that may be activated only during the periods when water is consumed. It is also an aim to provide an apparatus which is compact and may be installed in a simple and smooth way in, for instance, a dentist's surgery without requiring considerable space.

According to the invention, at least the primary object is attained by the features defined in the characterizing clause of claim 1. Preferred embodiments of the disinfecting apparatus according to the invention are furthermore defined in the dependent claims 2-7.

In a second aspect, the invention also aims at providing an efficient method for disinfection. The features of said method are seen in claims 8-10.

### DETAILED DESCRIPTION OF A PREFERRED EMBODIMENT OF THE INVENTION

Below, the invention will be described in detail with references being made to the accompanying single drawing figure, which constitutes a schematic illustration of the different details that are included in the apparatus.

In the drawing, 1 generally designates a service conduit for supply of cold water to an apparatus according to the invention, in its entirety designated 2. After passage through the apparatus 2, the treated water is fed to a consumption unit 3, which may consist of, for instance, a dental device, by means of which the water may be sprayed out in the form of fog or aerosols 4. For this purpose, the device 3 may in a conventional way be connected with an appliance 5 for supply of compressed air to the water.

By 6, an existing drainage is designated, to which excess of water may be removed from the apparatus 2.

Vital components in the apparatus 2 according to the invention consist of a heater 7 and a heat exchanger 8. At a point 9, the service conduit 1 (or an inlet conduit connected with the same) branches off into first and second branch conduits 10, 11, the last-mentioned one of which comprises a main valve 12. The conduit 10 communicates with the heater 7, through which cold water from the service conduit may be supplied to the heater and be heated in the same by means of a heating element 13. In practice, the heater 7 may consist of a vessel or a tank, e.g. of an acid-proof material, having a volume which is dependent on the number of connected consumption units 3. If only one consumption unit, e.g. for a dental chair, is connected with the apparatus, the vessel 7 may have a volume of 1-2 litres. If a plurality of consumption units are connected with one and the same apparatus, the vessel 7 may have a greater volume, e.g. approx. 10 litres.

Between the heater 7 and the heat exchanger 8, an intermediate conduit 14 extends, for supply of heated, disinfected water from the heater 7 to the heat exchanger 8. Furthermore, with the heat exchanger 8, two outgoing conduits 15, 16 are connected, the first-mentioned one of which constitutes a feeding conduit for treated, outgoing water to the consumption unit 3, while the last-mentioned one consists of a drain conduit, which constitutes a continuation of the cold-water branch conduit 11. The cooling water, which is taken into the heat exchanger from the conduit 11 when the main valve 12 is open, is thus evacuated directly to the drainage 6 via the conduit 16.

In the conduit system illustrated in the drawing, additional conduits 17, 18, 19 and 20 are included. The conduit 17 extends between the service conduit 1 and the feeding conduit 15, and comprises a second valve 21 in the form of a cut-off valve, which is kept closed during normal operation. The conduit 18 extends between the branch conduit 10 and the feeding conduit 15. In the conduit 18, a circulation pump 22 and a third valve 23 are included which, like the valve 21, consists of a cut-off valve which is kept closed during normal operation. The conduit 19 is connected with a valve device 24, located in the branch conduit 10, which is denominated valve stem by those skilled in the art. In said valve stem, a check valve function which prevents backward flow in the conduit 10 is comprised, as well as a safety function, which means that the conduit 10 may be opened towards the conduit 19 so as to evacuate water to the drainage 6 if sudden, unintentional pressure increases would arise in the heater 7. The conduit 20 extends between the conduit 18 and the intermediate conduit 14, and comprises a cut-off valve 25 that is kept open during normal operation.

In connection with the feeding conduit 15 outgoing from the heat exchanger 8, two temperature sensors 26, 27 are arranged, the first-mentioned one of which has the purpose of controlling not only the function of the main valve 12, but also the function of the valves 23 and 25. The valve 12 consists of a cut-off valve having a throttling function, i.e. the valve may not only be closed and opened, respectively, but may also be adjusted in different throttle positions in which a reduced water flow is attained. It should already now be pointed out that the temperature of the outgoing water from the heat exchanger 8 in practice should be within the range of 32-36° C. Suitably, the temperature should amount to 34° C. The second temperature sensor 27 has the purpose of opening the valve 21 if the temperature of the outgoing water by misadventure would exceed the predetermined limit value, e.g. 34° C. In this way, cooling cold-water from the service conduit 1 may be directly supplied to the feeding conduit 15 with the purpose of cooling the overheated water before the same reaches the patient via the consumption unit 3.

### FUNCTION AND ADVANTAGES OF THE APPARATUS ACCORDING TO THE INVENTION

When a working period shall begin, the heater 7 is activated, more precisely with the purpose of heating cold water that is taken in as a part flow from the service conduit 1. In said service conduit, the water may have a temperature of 8-12° C. In the heater 7, the water is heated to a temperature of at least 77° C., suitably 80° C. In the most preferred embodiment of the treatment method according to the invention, the water is heated to a temperature within the range of 90-95° C. At such temperatures, all possibly occurring disease-generating bacteria in the water are killed in an effective way.

When water is consumed in the consumption unit 3, a corresponding quantity of water is transferred from the heater 7 to the heat exchanger 8 in which the hot water is cooled to a temperature acceptable to the tissue of man, suitably 34° C. (also temperatures within the range of 32-36° C. are acceptable). The cooling of the water in the heat exchanger is carried out by the fact that the main valve 12 is opened, more precisely depending on the temperature read by the sensor 26, of the outgoing water from the heat exchanger. Thus, a motor included in the main valve regulates the part flow through the conduit 11 in such a way that the amount of cold water through the heat exchanger 8 is adapted to the quantity of hot water which is taken in from the heater 7 in order to provide the desired temperature of the outgoing water in the feeding conduit 15. If the temperature of the water fed out from the heat exchanger by misadventure would exceed the predetermined limit value, the temperature sensor 27 ensures that the valve 21 is opened, whereby cold water may be supplied to the overheated water in the feeding conduit before the same reaches the consumption unit. When water is not consumed, the water is circulated in the conduit 20 with the valve 23 kept close and the valve 25 kept open until the temperature sensor 26 calls for warmer water. As long as such circulation goes on, also the valve 12 is kept close. Thus, the last-mentioned valve is opened only when heat exchange is required.

On repetitive occasions, the apparatus may be cleaned by only hot water being rinsed through the conduit system. This takes place by the fact that the valve 23 is opened and the valve 25 is closed, and the circulating pump 22 being started. In this way, the water heated in the heater 7 may be circulated through the main part of the fixed conduit system of the apparatus, as well as be flushed through occurring tube or tubes in connection with the consumption unit 3. In this way, the risk of bacterial growth in the feeding conduit 15 and tubes and the like connected therewith, is counteracted. In connection with such a service flushing, the main valve 12 is kept close so that cooling water is not taken into the heat exchanger.

It should be pointed out that not only the vessels or tanks which form water heater and heat exchanger, respectively, but also the different conduits which are included in the conduit system of the apparatus may in practice be built into a held-together, compact housing. The conduits shown schematically in the drawing do not necessarily need to consist of conduits or tubes, but may also be formed by ducts in block. The included service conduit for cold water as well as the different outgoing conduits may be connected with the housing via suitable couplings, which are not shown in the drawing.

The feeding of water from the heater 7 to the consumption unit 3 via the heat exchanger 8 is in practice carried out by means of the pressure which prevails in the existing service conduit 1. Thus, in the conduit system up to the consumption unit 3 (the opening and shutting off of which takes place by means of a valve which is not shown) the same water pressure prevails as in the service conduit.

An advantage of the apparatus according to the invention is that efficient disinfection of consumption water may be effected without the help of chemicals. Furthermore, the apparatus is technically simple and may be installed in connection with existing consumption units without requirements for considerable space. Moreover, the apparatus has a low energy-consumption during operation thanks to the fact that energy only needs to be supplied to the heater on a level with intermittently repetitive consumption occasions.

1. Apparatus for the disinfection of water for water consumption units (3) designed for health or dental care purposes, wherein the same comprises a main valve (12) for dividing a cold-water flow, incoming from an existing service conduit (1), between a heater (7) for heating the cold water to a bactericidal temperature, and a heat exchanger (8) which has the purpose of cooling disinfected, hot water from the heater (7) to a temperature acceptable to the tissue of man, and wherein two outgoing conduits are connected with the heat exchanger, viz. a feeding conduit (15) for feeding disinfected water to the consumption unit and a drain conduit (16) which communicates with a drainage (6) for evacuation of cooling water, which has served its time, from the heat exchanger.

2. Apparatus according to claim 1, wherein the main valve (12) is arranged in a branch conduit (11), connectable to the service conduit (1), which passes through the heat exchanger (8) and transforms into the drain conduit (16).

3. Apparatus according to claim 1, wherein the function of the main valve (12) is controlled by a first temperature sensor (26) in the feeding conduit (15).

4. Apparatus according to claim 1, wherein a conduit (17), having a second valve (21), extends between the service conduit (1) and the feeding conduit (15), which is controlled by a second temperature sensor (27) in the feeding conduit (15), and has the purpose of supplying cold water to the disinfected water in the feeding conduit when necessary, if the same unintentionally would have an unacceptably high temperature when the same leaves the heat exchanger.

5. Apparatus according to claim 1, wherein a conduit (18) extends between a conduit (10) in-coming to the heater (7) and the feeding conduit (15) from the heat exchanger (8), having a circulating pump (22) and a cut-off valve (23), which is kept closed during normal operation, but may be opened when necessary in order to, by means of the pump, bring hot water from the heater (7) to circulate in the system of conduits with the purpose of disinfecting the same.

6. Apparatus according to claim 1, wherein a valve stem (24), having a built-in check valve function, is arranged between the service conduit (1) and the heater (7).

7. Apparatus according to claim 1, wherein the same is connectable with the feeding conduit thereof to a consumption unit (3) in which an aerosol-forming arrangement is included.

8. Method for the disinfection of water intended for water consumption units (3) for health or dental care purposes, including the steps of diverting a cold-water flow from an existing service conduit (1) and via a main valve (12) dividing the same into a first part flow to a heater (7), in which the water is heated to a bactericidal temperature, as well as a second part flow to a heat exchanger (8) in which the cold water cools the disinfected, hot water from the heater to a temperature acceptable to the tissue of man, and of feeding from the heat exchanger (8) the disinfected, cooled water to the consumption unit (3), as well as cooling water, which has served its time, from the heat exchanger (8) to a drainage (6).

9. Method according to claim 8, wherein the water in the heater (7) is heated to at least 77° C., suitably to at least 80° C.

10. Method according to claim 8, wherein the temperature of the disinfected water from the heater (7) is decreased to 32-36° C. in the heat exchanger (8).
